(19) United States
(12) Patent Application Publication
(10) Pub. No.: US 2002/0049961 A1
(43) Pub. Date: Apr. 25, 2002

(54) Rule-based personalization framework

(76) Inventors: Shao Fang, Castro Valley, CA (US); Kiran Prabhakar, Sunnyvale, CA (US); Venkat R. Srinivasan, Sunnyvale, CA (US); Tushar Shanbhag, San Carlos, CA (US); Vinay M. Srinivasaiah, Bangalore (IN); Bobby Berchmans, Kottayam (IN)

Correspondence Address: McAndrews, Held & Malloy, Ltd., 34th Floor, 500 W. Madison St., Chicago, IL, 60661, US

(21) Appl. No.: 09/925,241

(22) Filed: Aug. 8, 2001

Related U.S. Application Data
(60) Provisional application No. 60/164,021, filed on Aug. 23, 1999.

(51) Int. Cl. G06F 9/44

(52) U.S. Cl. 717/127

(57) ABSTRACT

A rule-based personalization framework wherein an administrative tool is implemented as a web application, and the tool allows a non-technical user—such as a business or marketing manager—to define and manage rules and deploy them in a runtime environment. A rule is comprised of a set of condition types and action types. The manager utilizes a set of routines to create new rules or to search for existing rules. The source code of an application or application page will have tags embedded therein for association of the various actions. A rule is thereby deployed by associating certain actions with certain tags within the application. As the application is rendered, the tag will be encountered and the action executed. Actions might also be arbitrary in nature, having a predetermined interface that is implemented by the action in order for the action to be implemented properly into the associated framework.

### RELATED APPLICATIONS

This application is related to the following—U.S. Provisional patent application having Ser. No. 60/164,021, entitled “Method and Apparatus to Provide Custom Configurable Business Applications from a Standardized Set of Components,” filed Aug. 23, 1999; Utility patent application having Ser. No. 09/440,326, entitled “Method for Providing Custom Configurable Business Applications from a Standardized Set of Components,” filed Nov. 15, 1999; Utility patent application having Ser. No. 09/439,764, entitled “Apparatus to Provide Custom Configurable Business Applications from a Standardized Set of Components,” filed Nov. 15, 1999; Utility patent application having Ser. No. 09/658,415, entitled “Method For Developing Custom Configurable Business Applications,” filed Sep. 8, 2000; Utility patent application having Ser. No. 09/658,416, entitled “Integrated Design Environment for a Commerce Server System,” filed Sep. 8, 2000; Utility patent application having Ser. No. 09/697,271, entitled “Method for Providing Template Applications for Use by a Plurality of Modules,” filed Oct. 25, 2000; Utility patent application having Ser. No. 09/691,461, entitled “Method and Apparatus for Providing News Client and Server Architecture and Protocols,” filed Oct. 17, 2000; Utility patent application having Ser. No. 09/684,491, entitled “Adapter and Connector Framework for Commerce Server System,” filed Oct. 4, 2000; Utility patent application having Ser. No. 09/702,148, entitled “E-Commerce Application Built Using Workflows on a Workflow Engine and Methods Thereof,” filed Oct. 30, 2000; Utility patent application having Ser. No. 09/702,290, entitled “Presentation Layer for Business Application Development and Methods Thereof,” filed Oct. 30, 2000; Utility patent application having Ser. No. 09/702,291, entitled “Scalability, Availability, and Management Features For Business Commerce Server,” filed Oct. 30, 2000; Utility patent application having Ser. No. 09/706,304, entitled “Content Management Framework for Business Commerce Server,” filed Nov. 3, 2000; and Utility patent application having Ser. No. 09/727,912, entitled “Workflow Driven Rules-Based Generation of Personalizable Web Page,” filed Nov. 28, 2000; and Utility patent application having Ser. No. (unassigned), entitled “Menu Infrastructure Apparatus and Method,” filed Jun. 27, 2001,—each of which is hereby incorporated by reference in their entirety.

### FIELD OF THE INVENTION

The present invention relates to a framework which allows personalized rules to be created and deployed to a live web site though a web interface, without further programming efforts and without interrupting the web site server. The framework also allows arbitrary business workflows (or actions) to be executed if certain conditions associated with a rule are satisfied.

### BACKGROUND OF THE INVENTION

Asera Commerce Server.

The prior referenced applications provide for methods and apparatuses for creating custom configurable business or channel applications from a standardized set of components. More specifically, the referenced invention(s) allow each business to select from a set of applications, customize that set of applications, and/or develop new customized applications from a set of development components. The prior applications provide for a server based method wherein best-of-breed services and/or applications are integrated in a seamless fashion and offered to enterprise businesses which develop customized business service applications through using the system. The server device is previously (and hereafter) referred to as the Asera Commerce Server (ACS).

The ACS includes a Commerce Server that provides a core set of technology (or application) services. A unique architecture and framework are provided by the Commerce Server, which facilitates development and use of customized applications. Most interactions with external systems or users are managed as Business Objects. The service application code is maintained separate from the data. This enables the system to quickly include (and/or change) new business processes or technology components without having to write substantial amounts of new code. The business result is more rapid customer deployments and/or modifications that are customized to include (if desired) the proprietary or competitive business practices of a contracting company.

The ACS can be viewed as a form of ASP (Application Service Provider). An ASP is generally an outsourcing business model. The ASP business model requires an open and extendable architecture that allows a system to implement a customer specific business solution in a short period of time. The ACS takes best-of-breed applications and incorporates them into one integrated solution to provide the ASPs. The architecture is scalable and extensible. A customized business (or channel) application solution is built for each enterprise company. The solution uses a “modular” or step-wise or “plug-and-play” approach towards building new applications. An enterprise company can then quickly acquire a turn-key e-commerce solution to automate their channel relationships. The system presents little (or no) risk for the enterprise company because a solution is built by the present system. The costs of undertaking such a development exist as a fixed development cost of the system. Any resulting customized solutions are implemented in considerably less time than previous systems. The enterprise company might pay for the application services on a cost per transaction or a fixed-fee basis.

The ACS is used to capture the particularized (or specific) business processes for a given customer, and these business processes are converted into a set of customized applications. The ACS uses business steps and rules to construct the application. The objects are data representations. The steps are business operations with a defined set of input and output ports, with each port also having a defined set of parameters. The business rules are used to capture customer specific business practices. A unique tool that employs a graphical user interface graphical user interface (GUI) allows a developer to arrange various steps (or composite steps) into business processes or workflows. The tool provides library catalogs of steps to be applied to the various objects. The connections between steps are also verified as correct. A graphical display of the business process is shown, and rules can thereafter be applied to provide further customization by conditionally tagging certain points. Hence, to create a business process (or application) for any given business, tools are provided which allow modules (or steps) to be plugged or dropped into the potential process. The steps can be moved or the connections modified. An initial person-to-person (or other type of) interview with the business (or customer) can be used to produce the framework for arranging the steps according to the needs of that particular business (i.e., customized routines). The modular aspect of the present system allows this to be done—and modifications made—in a relatively quick fashion. For instance, if a process has been created, but the customer wants it to behave in two different manners, then certain rules can be applied to provide the desired results, depending upon conditional triggers that can be associated with the underlying Business Objects.

Rule-based Personalization Framework.

Once a web site is running from a web server, an administrator or business manager will often need to invoke the performance of various actions which might be needed by the user or the administrator of the site. In general, the pages of a web site are dynamically generated from a framework of templates and Hypertech Markup Language (HTML) generators, which comprise a source page. Each segment of code on the source page might be responsible for generating a different part of the resulting display page. If a business manager needs to insert a display event (or some other type of event), within a set of web pages, then the physical code associated with generating the page must be directly altered (or more code generated and inserted). Further complicating the coding requirement is the concept of a rule being associated with a particular action. A rule might test certain conditions associated with the particular page or the page user. If all of these rule conditions are satisfied, then the action will be executed. Such logical sequencing generally requires further coding in order to test the desired conditions and conditionally produce the desired result.

Given that a business manager might not be technically capable of invoking such changes, a code developer would then need to be called to facilitate the additions. Oftentimes, this also requires that the web site, or associated web server be shut down while the code (or HTML generating segments) of the requisite source page(s) is altered. This is unacceptable in a runtime environment where services are being provided to a large number of users (for instance, the Asera system). Under such a system, many different users are relying on the server to remain available to run their applications.

Accordingly, what is needed in the field is a framework for allowing a non-technical developer, such as a business manager or the like, to define a personalized rule (or set of rules) and deploy these rules to a live web site through an associated web interface. A rule might generally be comprised of a set of conditions followed by a set of resulting actions. The definition and deployment of the rules should occur without interrupting the services being provided by the web site. Additionally, the framework might be configured to apply any action (or workflow) as dependent upon the conditions of an associated rule being satisfied.

### SUMMARY OF THE INVENTION

The present invention provides a rule-based personalization framework wherein an administrative tool is implemented as a web application, and the tool allows a non-technical user—such as a business or marketing manager—to define and manage rules and deploy them in a runtime environment. A rule is comprised of a set of condition types and action types. The manager utilizes a set of routines to create new rules or to search for existing rules. To create rules, the manager selects from a set of rule conditions which might include (but is not limited to) user community, time, and page content. A set of actions is also provided, which will be performed once the conditions are satisfied for a particular rule. The rule is then saved for future reference. A listing of rules can be invoked which will show available rules that were already created and are available to the particular user. New rules will also be shown in the listing.

The manager then selects the desired rules for deployment. To deploy a rule, the actions need to be associated with certain tags (personalization tags) that have been defined in specific locations in the source listing for each application page. These application pages might consist of wire frames, and master template HTML files.

The tags are registered to a centralized file so that they can be quickly referenced. Note that pages will have different kinds of tags distributed in their source listings. The tags might affect one page or multiple pages, depending on the type of tag. These tags will be searchable by the manager—according to the application and associated pages—in order to determine which application/pages might be able to handle deployment of a particular action. The manager can therefore use the web-based interface to create (or select) a rule and then apply the action to certain pages.

Each source page is developed with the tags in designated places, accordingly to anticipated needs of the user of the application. For instance, personalization tags are embedded into wire frame and master template files at activation time, based upon customer requirements. Adding additional tags will require activation involvement.

With these tags as part of the framework, the rules can be deployed during runtime and the actions will produce the desired result in the desired location on the page. The framework will evaluate the user profile condition based on the current visitor, evaluate the time condition based on the current time, and evaluate the content condition based on the current page content. If all the conditions are satisfied, then the action workflow will be executed. A simple runtime example might include: (a) Perform this action—Promote products in Category X; (b) For visitors in these user communities—user community #1 . . . through user community #N; (c) Following the schedule—summer promotion period; (4) When page content matches the condition—viewing details of consumer durable goods. The deployment of a rule will not require further programming efforts by the developer and will not interrupt the running of the web site.

Still another feature of the framework allows for an arbitrary action—which might be thought of as a business workflow—to be executed, once the conditions associated with that action have been satisfied. The framework therefore does not restrict the functionality implemented by action workflow. In the past, a rule was developed with a particular action to be performed. The framework was thereby configured to handle certain kinds of actions. If new actions were to be added to the overall framework, then existing rules—as well as applications—might need to be rewritten.

The present system instead provides for an arbitrary action to be associated with the set(s) of conditions comprising a rule. This action (or workflow) will implement a predetermined interface, which will then interact with the framework according to the known parameters. Any action can thereby be performed with the proper flow of information through this interface. Example action workflows might return HTML snippets, send out emails, write to a system log, and/or modify some dynamic attributes in the user profile. The framework is extensible and allows additional action types to be incorporated in future releases. In other words, any business workflow can be executed through the present personalization framework.

Accordingly, one aspect of the present invention is a framework for implementing and deploying personalized rules for performing certain actions in association with at least one application running on a processor device in a distributed computer network, the framework comprising: at least one rule having a set of conditions and associated actions; at least one application page associated with each application; and at least one tag defined in a known location of the at least one application page, wherein a rule is deployed by associating certain actions with certain tags, with the action being executed when the tag is encountered in rendering the application page, and the set of conditions for the associated rule is satisfied.

Still another aspect of the present invention provides a framework for implementing and deploying personalized rules for performing certain actions in association with at least one application running on a processor in a distributed computer network, the framework comprising: at least one rule having a set of conditions, the set of conditions being associated with an arbitrary action; at least one application page associated with each application; and at least one tag defined in a known location of the at least one application page, wherein a rule is deployed by associating the arbitrary action with certain tags, with the arbitrary action being executed when the tag is encountered in rendering the application page, and the set of conditions for the rule are satisfied.

Still another aspect of the present invention provides for a tool for implementing and deploying personalized rules for performing certain actions in association with at least one application running on a processor in a distributed computer network, the tool comprising: at least one interface for creating rules having a set of conditions, the set of conditions being associated with at least one action, whereby the rules are retrievably stored; at least one interface for searching and retrieving a list of created and existing rules; and at least one interface for deploying the rules by selectively associating the actions of certain rules with certain tags, each tag having been defined in a known location of the at least one application, wherein the action is executed when the tag is encountered in the process of rendering the application, and the set of conditions for the associated rule are satisfied.

The above and other features, aspects and advantages of the present invention will become apparent from the following descriptions and attached drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a block diagram, according to one aspect of the present invention, showing conditions and actions associated with certain rules.

FIG. 2 is a block diagram, according to one aspect of the present invention, showing representative tags that have been inserted into a source page.

FIG. 3 is a prior art block diagram, showing certain steps that can be used in deploying a rule into a source page.

FIG. 4 is a block diagram, according to one aspect of the present invention, showing certain representative steps that can be used to deploy a rule into a source page during runtime.

FIG. 5 is a block diagram, according to one aspect of the present invention, showing certain representative steps associated with deployment of a rule.

FIG. 6 is a block diagram, according to one aspect of the present invention, showing a representative interface for listing tags and controlling/editing deployment of rules to those tags.

FIG. 7 is a block diagram, according to one aspect of the present invention, showing a representative interface for manipulating the deployment and execution of rules.

FIG. 8 is a block diagram, according to one aspect of the present invention, showing a representative interface for manipulating action types.

FIG. 9 is a block diagram, according to one aspect of the present invention, showing the interface associated with an action.

FIG. 10 is a block diagram, according to one aspect of the present invention, showing a more specific instance of the interface associated with an action (i.e., Display Promotion).

FIG. 11 is a block diagram, according to one aspect of the present invention, showing certain representative administrative and manager functionality associated with Rule-Based Personalization.

FIG. 12 is a block diagram, according to one aspect of the present invention, showing certain features associated with the User Community Manager.

FIG. 13 is a block diagram, according to one aspect of the present invention, showing certain features associated with the Time Condition Manager.

FIG. 14 is a block diagram, according to one aspect of the present invention, showing certain features associated with the Content Condition Manager.

FIG. 15 is a block diagram, according to one aspect of the present invention, showing certain features associated with the Action Manager.

FIG. 16 is a block diagram, according to one aspect of the present invention, showing certain features associated with the Rule Editor.

FIG. 17 is a block diagram, according to one aspect of the present invention, showing certain features associated with the Rule Deployer.

FIG. 18 is a block diagram, according to one aspect of the present invention, showing certain features associated with the Deployment Pool.

FIG. 19 is a block diagram, according to one aspect of the present invention, showing certain features associated with the Rule Evaluator.

FIG. 20 is a block diagram, according to one aspect of the present invention, showing certain features associated with the Content Group Administration.

### DESCRIPTION OF THE PREFERRED EMBODIMENTS

The present invention provides a framework for allowing personalized rules to be created and deployed to a live web site, through a web interface, without further programming efforts and without interrupting the web site. The framework also allows an arbitrary business workflow (i.e., action) to be executed if certain user conditions are satisfied. For instance, conditions relating to the user's profile, time of use, and/or the application page content might be used to trigger the execution of an action. While described below in terms of certain example systems and servers (ACS, or otherwise), the principles of the present invention are meant to be fully applicable to other systems. Any description relating to a particularized example is to provide clarity only in describing the invention and is not intended to be limiting in any way.

Under the present system, a non-technical type of person (i.e., a business manager or the like), can utilize a GUI during runtime to deploy business rules that have been defined or created by the user. The framework relies upon tags that have been placed in the source pages associated with applications. The tags are registered and accounted for according to the types of actions that can be facilitated. Upon creating or selecting the rule, the business manager will associate the execution of the actions associated with the rule with the appropriate tags. At runtime, the tags will then execute the actions (or workflow) when the tags are encountered in the source code of the pages. Another embodiment of the present system will allow for any workflow to be executed, and therefore the functionality will not be restricted by the particular type of action that might be assigned to a particular rule. As additional action types are created, they can readily be incorporated into future versions of the framework.

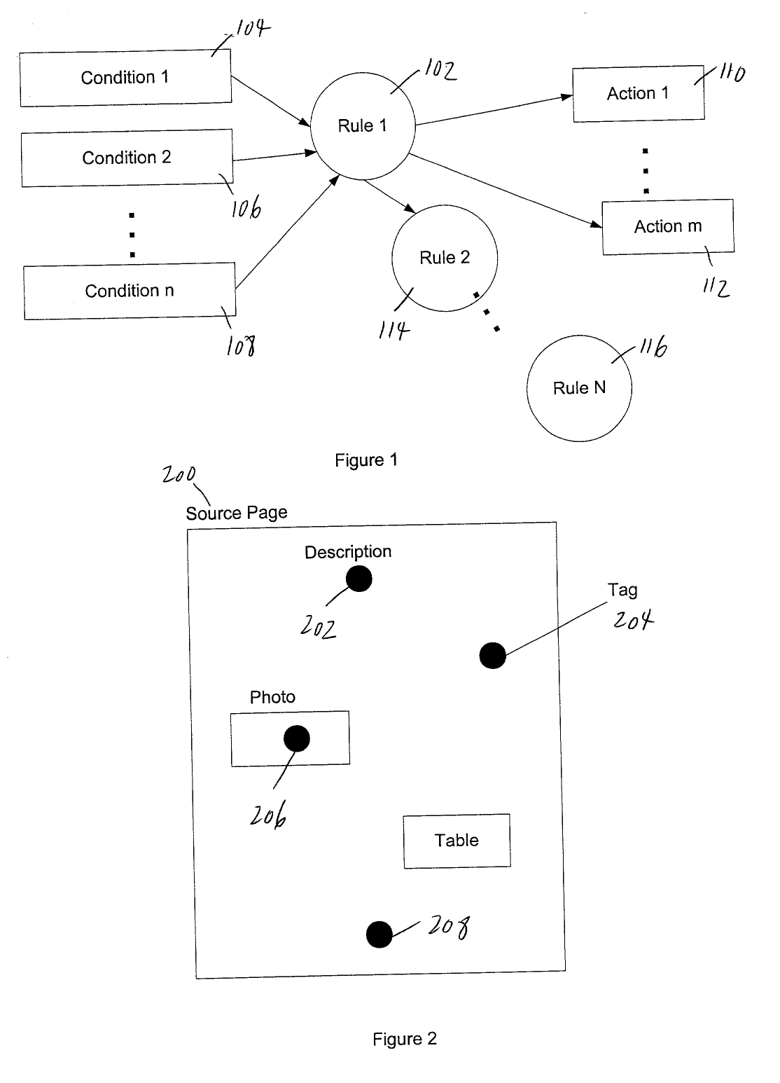

Referring now to FIG. 1, a representative block diagram is shown of certain components that might be used to comprise a rule. Rule 1 (102) is shown having a set of conditions, namely condition 1 (104), condition 2 (106), and so forth through an arbitrary number “n” of conditions, or condition “n” (108). While any set of conditions might be used, the example embodiment presented herein utilizes the conditions of (1) user community, (2) time, and (3) page content. According to the example framework, the users are grouped into different communities (i.e., user community 1, user community 2, and so forth). User communities might correspond to the different types of access levels or types of users (i.e., buyers, sellers, managers, end users, etc.). The time condition might be used to invoke actions only during certain hours, days, or seasons. The page content condition is utilized when a user is viewing certain content on a page. For instance, the very act of viewing one type of content on the page might conditionally produce the display of another type of content.

A plurality of resulting actions (or workflows) can be associated with the conditions. When these conditions are satisfied, the associated action will be performed. Example actions are shown as Action 1 (110), and so forth, through Action “m” (112). In general, the framework does not limit what action can be performed. Examples of such actions include sending out an email, writing to a system log and/or returning an HTML fragment for display. For any given rule, there should be at least one condition and at least one associated action. A series of similar rules is shown thereafter as Rule 2 (114) and onward through Rule “N” (116).

The GUI can present the conditional choices and action choices to be used in formation of the rule in any of a variety of ways. For instance, a series of palette-type menus can be presented, along with drop-down menus, and radio-select buttons for selecting the various conditions that might comprise a rule. The actions might similarly be presented via such menus. Each rule will then be associated with a set of tags that is capable of handling the result produced by the actions. The tags might be presented via similar menu types, or tables, or the like. This GUI, which might be supplied via a web interface, provides a simplified method for a non-technical business manager to construct (and later deploy) rules to a site.

Referring now to FIG. 2, an example source page 200 is shown which might be used to generate a display page. According to the present invention, a variety of markers needs to be inserted on the pages. These markers are herein referred to as “tags” and are used as a place to display or execute supplementary information (or the like). The various tags are inserted by the code developer into the source page according to the anticipated requirements of the application or end user who will be viewing the page. The tags are inserted at some point, before the site goes live, by a professional services group or the like.

The Asera system provides for the dynamic generation of HTML pages, wherein there are different sections of the pages that will be generated at runtime. The Asera system provides for the definition of wire frames, which will contain templates for the generation of HTML fragments, and these fragments are generated at runtime. According to the example in FIG. 2, the tag 202 has been inserted below the initial description. Tag 204 has been inserted in the general vicinity of the right-hand portion of the page. Tag 206 is associated with an area for displaying a photo. Tag 208 has been inserted at the bottom of the page, below an area for a table. As patterns of tags are dispersed in the pages, the user can selectively utilize the tags to accommodate the various actions associated with a rule. The tags are then registered with the system, before the system goes live, so that the tags can be referred to later for the deployment of rules. This dynamic deployment of the rules is one particular aspect of the present invention.

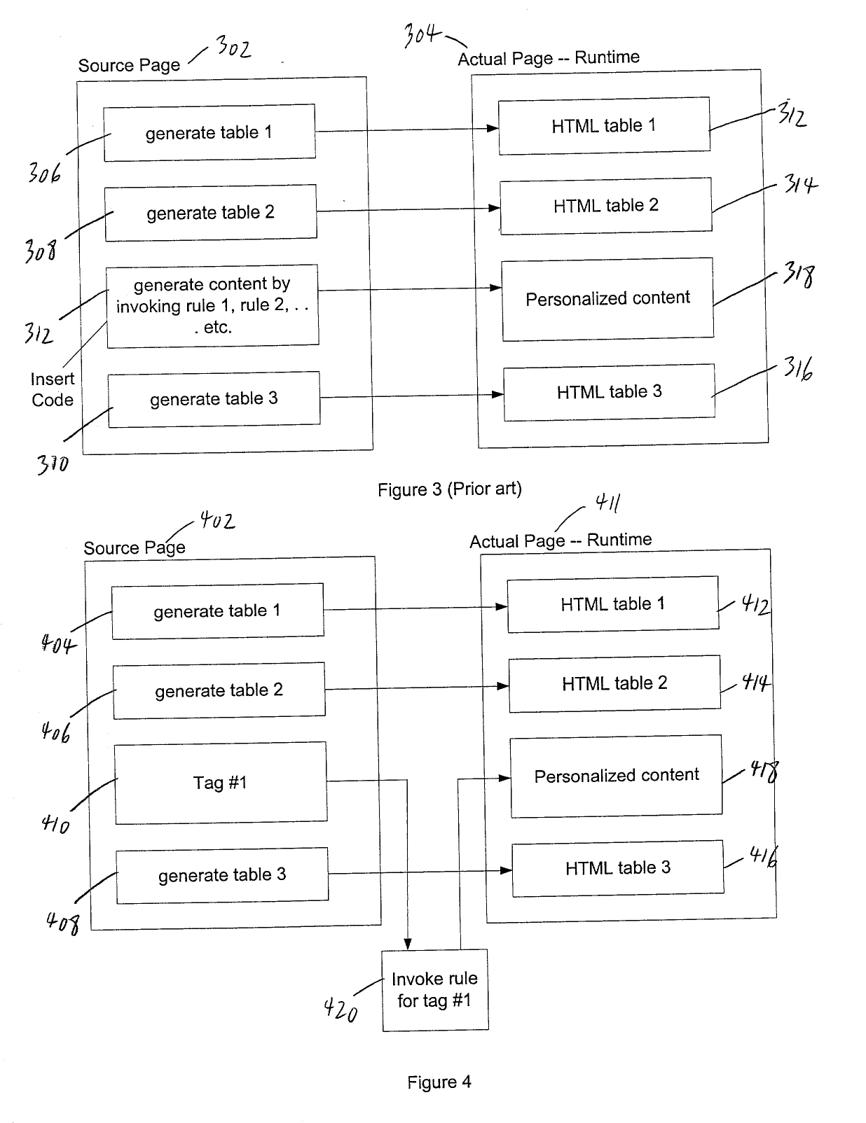

Once a rule has been selected or created, then it needs to be deployed. The business manager can use a web interface to provide a listing of which applications and/or pages can accept the formed rules. This listing is derived via the registered tags. In contrast, prior art systems need a programmer or code developer to deploy the various rules. Referring now to FIG. 3, an example of a Source Page 302 and an Actual Page (at runtime) 304 are shown. The Source Page 302 is shown to include source code to generate table 1 (306), generate table 2 (308), and generate table 3 (310). Certain content is required to be displayed between table 2 and table 3. Accordingly, the source code file is edited by the developer in order to insert code 312 to conditionally generate the required content, according to the particular rule that might be associated with the content. In the Actual Page 304 (during runtime), the resulting HTML table 1 (312), HTML table 2 (314), and HTML table 3 (316) will be generated in their appropriate positions on the page. The personalized content 318 is also generated in its appropriate position according to the coded rule.

FIG. 4, in contrast, demonstrates the approach of the present framework. The source page 402 is instead constructed with the appropriate code to generate table 1 (404), generate table 2 (406), and generate table 3 (408). A tag #1 (410) has been inserted in the location between table 2 and table 3. When the Actual Page 411 is generated during runtime, an assigned rule (420) is invoked for this tag. The Actual Page 411 thereby shows the resulting HTML table 1 (412), HTML table 2 (414), Personalized Content 418, and HTML table 3 (416), which are generated during runtime in the appropriate positions.

The tags can be categorized into different categories. Examples might include tags that affect only one page, such as application specific tags. Such specialized tags go only into one wire frame and can be used to change aspects, such as the color scheme, or the like, for that page only. Still other types of tags will affect multiple pages, such as master template tags. Master templates are used by many different applications, and therefore the selection of a master template tag will produce this result across all of the applications which might utilize that master template. Still other tags might allow the selection of a master template. For instance, for one type of content, a three-column format might be desired. For still another type of content, fewer columns might be desired. Depending upon the condition of page content, this type of tag will allow for a master template to be specified. Still another type of tag will allow for selection of a cascading style sheet (C.S.S.) depending upon a condition type being satisfied.

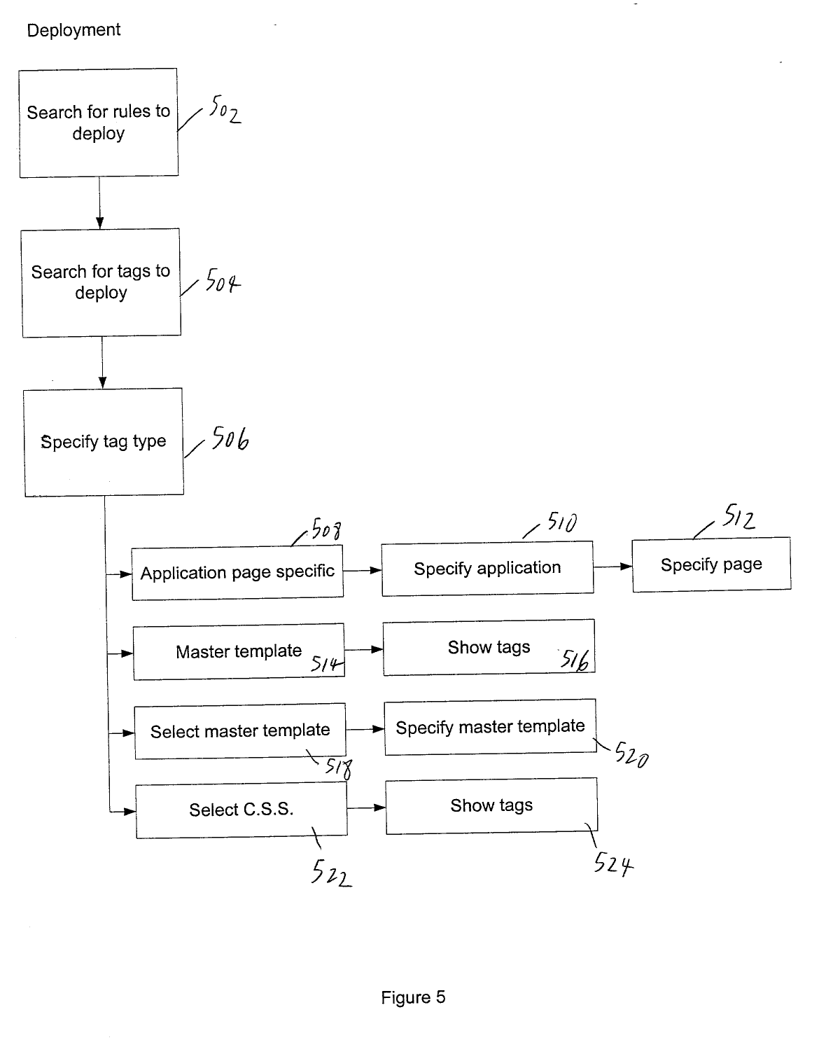

Referring now to FIG. 5, a block diagram is shown with representative steps that might be used in the process of deployment. A user can create new rules, or search for existing rules, according to the user needs. Block 502 shows the step of searching for rules to deploy. The business manager will generally be aware of what kinds of tags are available and locate tags to fit the needs of the particular rule to be deployed. Block 504 shows the step of searching for tags, whereby the rules will be deployed to these tags at runtime. Certain search criteria might be specified by the business manager, and the results will be used to show what types of tags are available for use. Block 506 shows the step of the user specifying a tag type. The type of tag selected thereafter will lead to or drive the next step. If an application page specific tag 508 is chosen, then the next step will be to specify the application 510. Thereafter, the pages from the application will be specified in step 512. If a master template tag 514 is specified, then the step thereafter is to show the user the tags associated with that master template. The tag type might facilitate the selection of a master template as shown in step 518. The user would then specify a master template as shown in step 520. Still another tag type might facilitate the selection of a cascading style sheet (C.S.S.) wherein the tags would be shown thereafter in step 524. These four types of tags are supported by the present embodiment, but a wide variety of other types of tags can be similarly added.

This overall process is similar to browsing for information in the framework. The user will search for tags, then specify what type of tags are to be used, and then select the appropriate tags from the listings. Note that each tag will show supplementary information regarding the type of information that the tag can handle. For instance, certain tags might have vertical limitations on the type of content that can be handled. Still other tags might have horizontal limitations. Further limitations might include a narrower width, or a more limited height, or the like, for that portion of the page where the tag is located. At the point of deploying the rule, the business manager will know certain parameters associated with the rule, and thereby browse through the list of pages. These listings will show where all of the tags are in association with the associated pages.

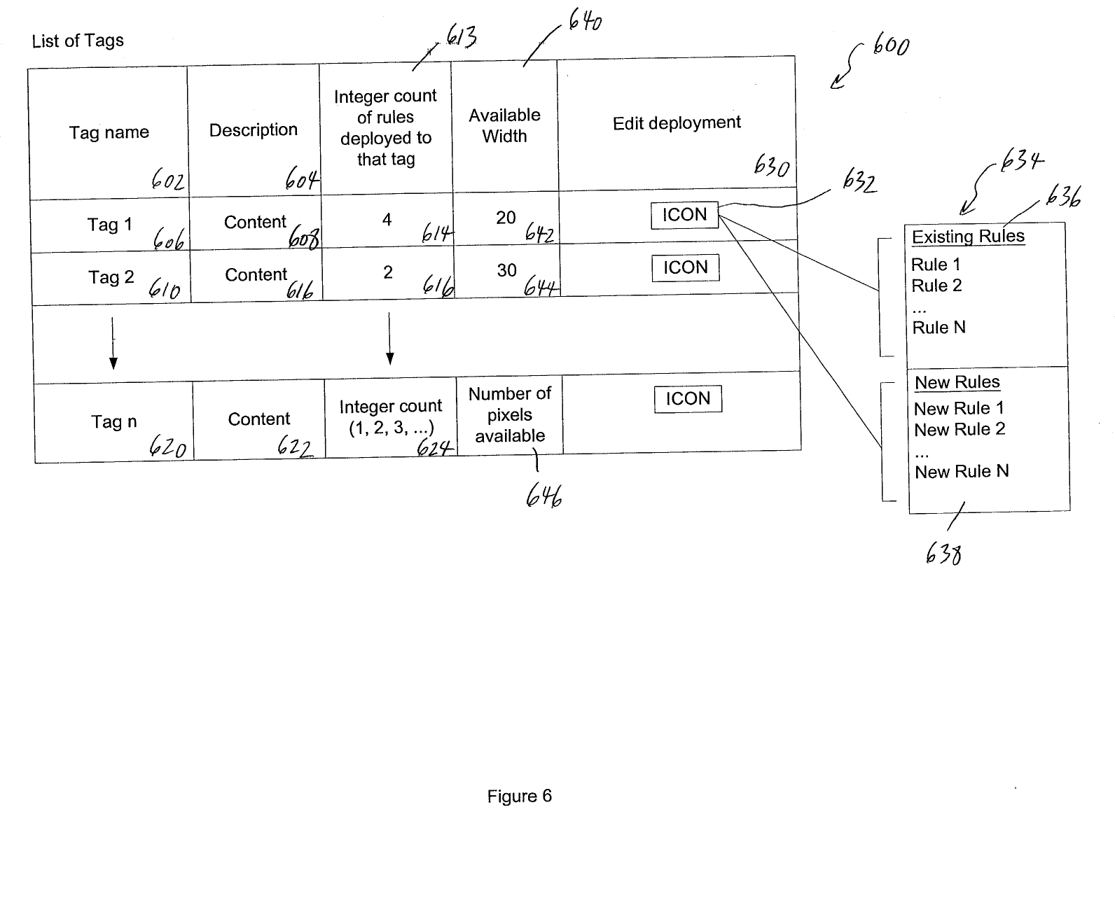

FIG. 6 next shows a representative table or listing 600 of tag information that might be presented to the user. The tag name 602 is shown, along with an area for a description 604 of the type of action that can be handled by the tag. For instance, for the first item Tag 1 (606)—the description type includes providing content material (608) to the user. Tag 2 (610) similarly provides content material (612). This list can contain a plurality of tag listings up to “n,” as shown by the entry Tag “n” (620), which is also capable of handling content material 622.

Column 613 of this listing provides an integer count of the particular rules that are deployed to that tag. Note that it is important not to have too many rules associated with each tag. The more rules that are associated with a tag, the longer it will take to generate a page containing that tag. In this example, Tag 1 (606) is shown to have multiple rules (i.e., 4) 614 associated therewith. Tag 2 (610) is shown to have only two rules 616 associated therewith. Tag “n” (620) is shown to generically have an integer count (i.e., 1, 2, 3, . . . ) (624) associated therewith.

Column 640 is used to show the available width for each tag. This column indicates the number of pixels (or other such measurement units) available for rendering HTML snippets at the wire frame location marked by each tag. For instance, Tag 1 is shown to have an available width of 20 pixels (642), and Tag 2 is shown to have an available width of 40 pixels (644). Tag “n” is generically shown to have a certain number of pixels available. The available width property of each tag is registered with the rule based personalization framework before the web site goes live.

The final column 630 will provide an Icon 632 that will allow the user to see a list of the rules that have already been deployed to that tag. A representative list 634 shows a set of existing rules 636 and new rules 638. The existing rules 636 (i.e., an arbitrary number 1 through N) have already been created, in most instances by another member of the present user's group or organization. The new rules (i.e., a different arbitrary number 1 through N) 638 have been created by the present user, and are also associated with this tag. The Icon will allow a user to “drill down” directly from the tag to the specifics for that listed rule.

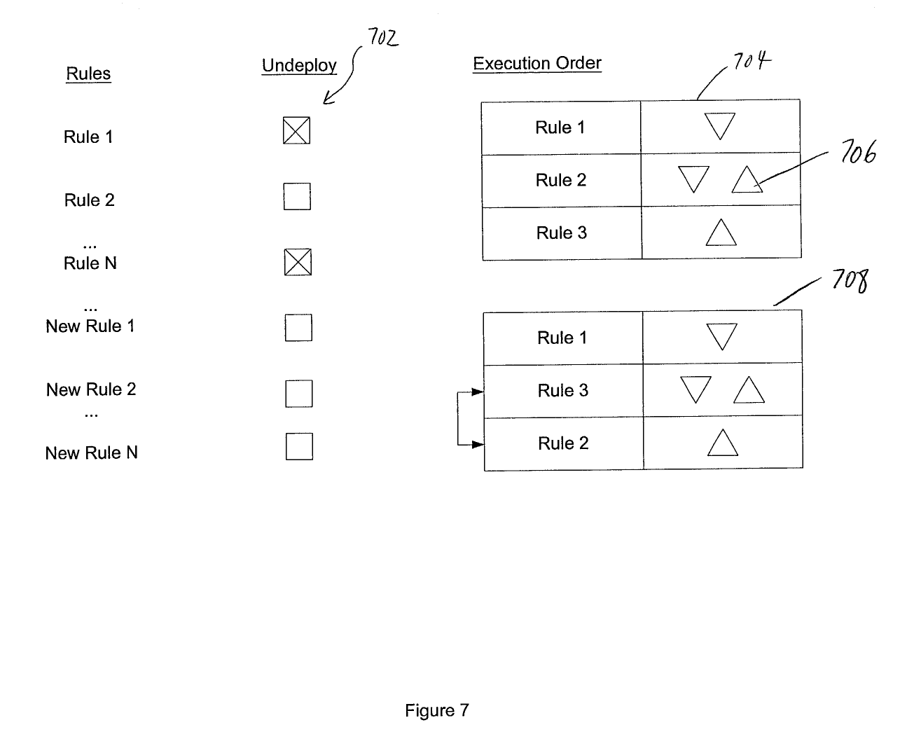

FIG. 7 next shows that a user will have the ability to undeploy certain rules that have been associated with a particular tag. As mentioned above, too many rules associated with one tag will slow down generation of that page. Hence, a user might desire to undeploy rules that have already been deployed, most likely limited to rules that have been assigned within the same organization. A series of boxes 702 is shown where a user can mark each rule for undeployment. Deployment and subsequent undeployment will be contingent upon the security level of the current user. For instance, if a user is partnered with others within the framework (or user communities within the framework), then the user might be allowed to undeploy these rules from the particular tag. In general, the rules will be stored in a temporary storage area associated with the framework, and new rules will be appended to this list as it is created.

A further feature of this representative page in FIG. 7 is the ability to arrange the execution order of the rules. While any arrangement technique might be used, the present system displays the execution order in a table 704, with the rules listed on the left and up-down arrangement arrows 706 shown on the right. By clicking on the appropriate arrows, the relative order of the rules can be shifted, as shown in the subsequent table 708, wherein rules 2 and 3 have been shifted in their ordering. In prior systems, where the rules have been hard-coded into the pages, a change in execution ordering would require rearranging the underlying code. The present system instead relies upon the stored execution order to evaluate the rules, and then perform the actions in association with the assigned tags.

In general, any type of action can be invoked under the present framework. The framework is flexible and extensible and does not limit (by the type of action) what type of action can be performed. Each action is essentially a workflow, and the underlying framework looks for a workflow to execute. The Asera workflow format is particular to the various advantages provided by the Asera framework. Other general workflow formats include Microsoft active server pages, Java server pages, and/or the simple invocation of a (URL).

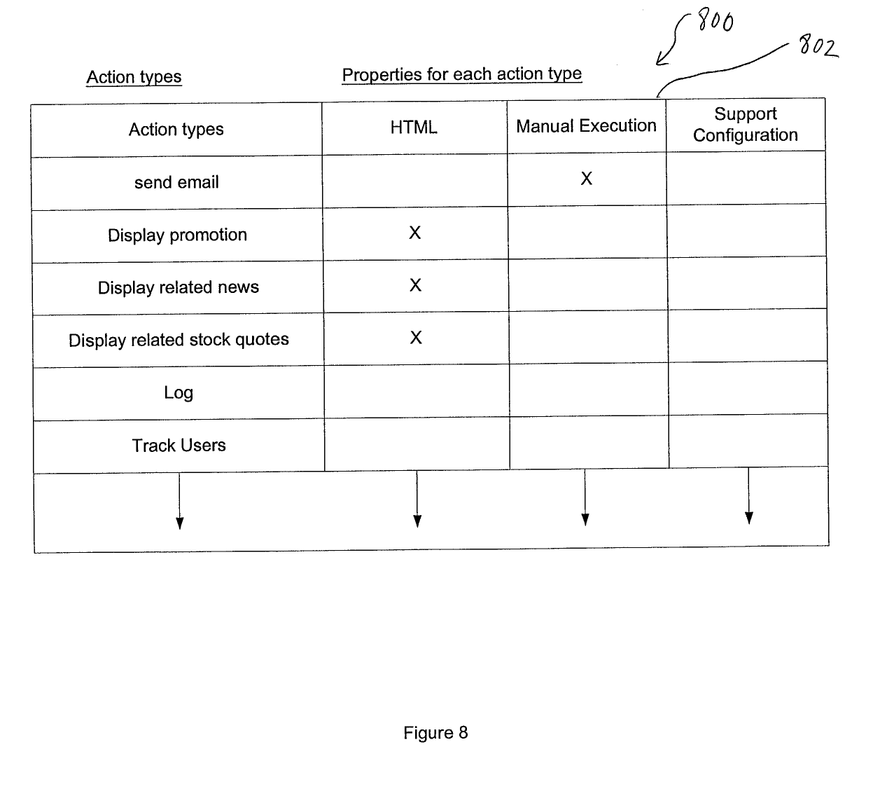

For each action type, a set of properties needs to be declared and made available to the underlying framework. Properties might include an indication of whether the action can return an HTML fragment. Another property might be whether the action can be executed manually or not. Still another property might include whether the action type supports configuration. FIG. 8 shows a listing 800 with various example action types, including (but not limited to) send email, display promotion, display-related news, display-related stock quotes, log and track users. The properties for each action type are shown on the right 802, with certain boxes being checked to signify the properties. The action types, including display promotion, display-related news and display-related stock quotes are shown to generate HTML fragments. The action type of sending email are available for manual execution.

The framework will provide an interface, with a specific protocol that the framework will need to act with an individual action-type code. To be supported by the personalization framework, the action type needs to implement these certain interfaces (i.e., Java interfaces, or the like). Accordingly, the action type will communicate (in a set way) with the framework through these interfaces. In order for the framework to act appropriately, the set of properties thereby needs to be exposed to the framework. For future releases, if new action types are to be added to the framework, then the action types simply need to incorporate and adhere to the interface in order to be able to talk to the framework.

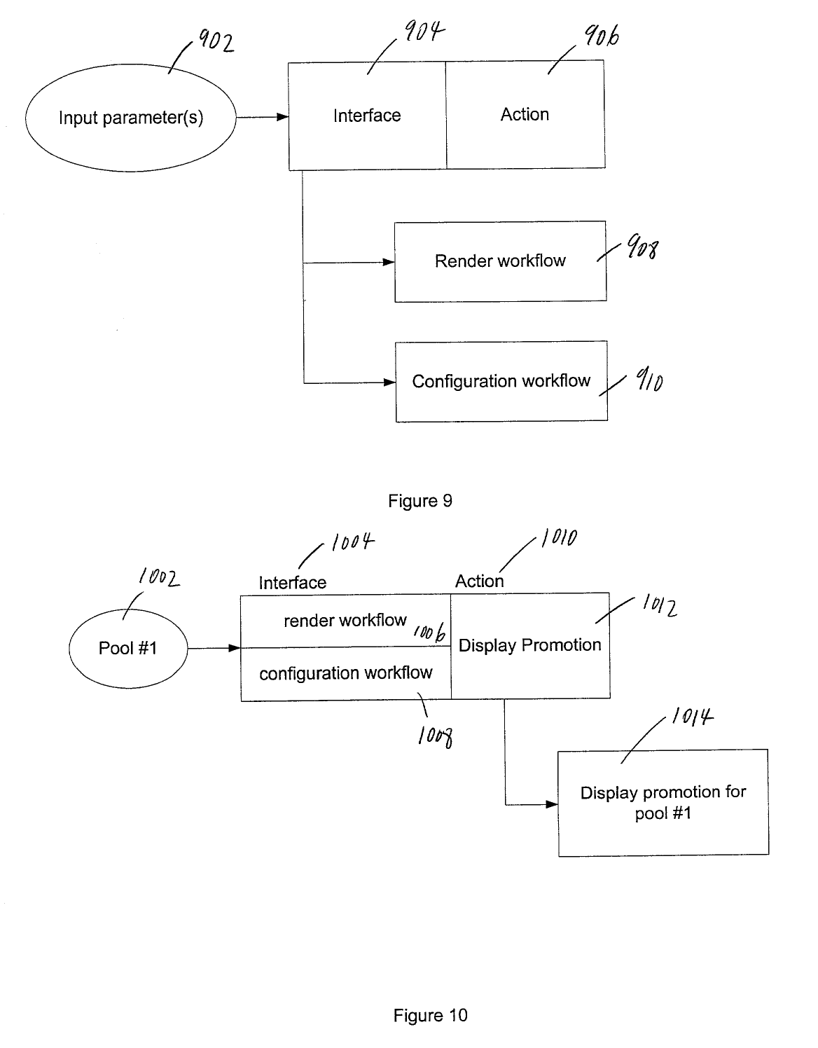

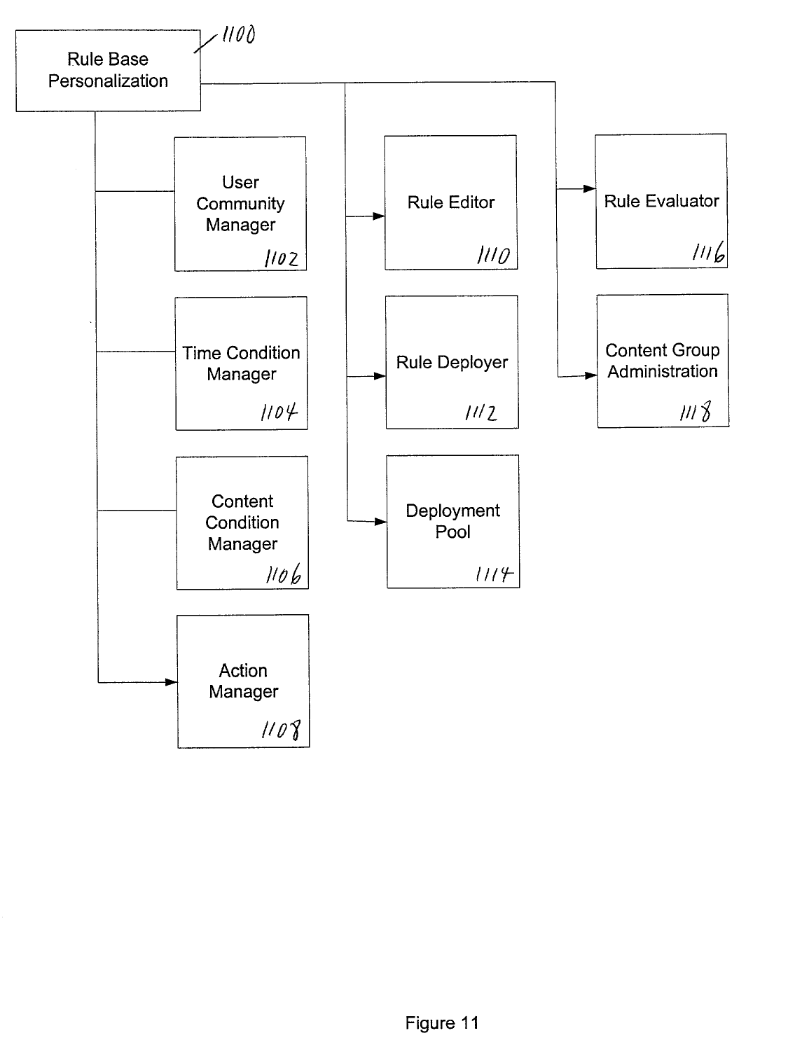

FIGS. 9 and 10 serve to further demonstrate the aforementioned interface to be used with a particular action. If the action supports configuration (for instance), then the action provides (at least) two workflows to the framework. These two workflows include: render workflow and configuration workflow. The render workflow is generally required, but the configuration workflow is optional. For instance, if a display always shows the same promotion for a certain rule (Rule #1), then the framework will not allow the business manager to change the display content at runtime. In such an instance, the configuration workflow is not needed. The render workflow is needed, however, in order to perform the action part of the workflow.

While a workflow can be any of the following, i.e., any active URL, ASP page, JSP page, CGI script, the present example is described in terms of an Asera workflow. FIG. 9 shows an input parameter 902 which is used by the interface 904. The interface 904 is implemented by the associated action 906. The interface 904 is further comprised of a render workflow 908 and a configuration workflow 910. In terms of a specific example, this is further explained in FIG. 10. The input parameter is Pool #1 (1002). The interface 1004 is again comprised of the render workflow 1006 and the configuration workflow 1008. The action 1010 is exemplified by the type display promotion 1012. From the user interface, the business manager has configured the action type display promotion as part of Pool #1. The configuration workflow will allow the business manager to choose from any of a variety of input pools (i.e., #1, #2, etc.). The render workflow is invoked at runtime. If a set of conditions is satisfied (according to the rule), then the render workflow is invoked with Pool #1 being passed in as a parameter. The result might be a display promotion for Pool #1, as shown in block 1014.

Additional action types can be added with new releases of the system. There will be a set of parameters associated with each action type. Based upon the parameters, the framework will hook into the right places inside the user interface. For a configuration workflow, certain entries can be added to configure it, and/or a validation can be performed thereafter. Note that the listed examples are simply flags or Boolean operators on the object. For backward compatibility, certain default values will be provided for all older action types.

The rule-based personalization framework and administration tool (i.e., GUI, web interface, or the like) will provide business needs, including (but not limited to) the following: deliver-related content based on user profile, time, and application page content; display personalized promotions and enable targeted marketing; allow for cross-sell and up-sell of products; track user visits through application pages to build a user profile database; send targeted promotion and notification emails based upon the user profile.

More specifically, the rule-based personalization framework 1100 will include functionality (i.e., software modules, or the like) such as those shown in FIG. 11. These include (but are not limited to): User Community Manager 1102; Time Condition Manager 1104; Content Condition Manager 1106; Action Manager 1108; Rule Editor 1110; Rule Deployer 1112; Deployment Pool 1114; Rule Evaluator 1116; Content Group Administration 1118.

The User Community Manager 1102 is a module for use by the business managers to identify user communities by entering criteria on user profile attributes. User communities are employed to restrict the applicable users for each personalization rule. For instance, the action for a rule earmarked for user community “Western Region Sales Managers” will be executed for only visitors whose profiles satisfy the criteria of the user community. The module will allow user communities to be defined and named, searched, viewed, edited, copied, and deleted.

The User Community Manager 1102 allows business managers to identify user segments by constructing a criteria consisting of any number of Boolean expressions on user attributes, combined using the Boolean operators (i.e. AND, OR). There is generally no restriction on the criteria format. Business managers assign unique names to user communities to facilitate re-use and allow new user communities to be defined using existing user communities. When a personalization rule is evaluated at run time, user community membership evaluation is performed using the current visitor. The criteria defining each user community can also be transformed into a query to retrieve from the user database all the users whose profiles satisfy the criteria. Database tables (and the like) are used to persist user community objects. Java API's are provided to return user communities based on user community canonical ID or partner ID, and to evaluate user community membership given a specific user ID.

The Time Condition Manager 1104 is a module used to define the validity period for a personalization rule. A valid schedule for a personalization rule may include start time, end time and recurrence specification. The module will allow named schedules to be defined and named, searched, viewed, edited, copied and deleted. Defining a time condition or “schedule” is similar to scheduling an appointment in an electronic calendar. Simple start date/time, end date/time, intra-day active duration, and daily/weekly/monthly recurrences are supported. Both specific and “floating” time zones specifications can be used, wherein the business managers can specify a specific time zone, such as PST, or use the current visitor's own time zone. Business managers assign unique names to the time conditions to facilitate re-use. Database tables are used to persist time condition objects. A Java API can be used to evaluate time conditions.

The Content Condition Manager 1106 is a module used to define the valid page content under which a personalization rule should be invoked. Content conditions restrict the applicability of personalization rules to specific application page content. For example, the action for a rule with the content condition “Viewing Wearable Details” will be performed only when visitors view the details of products in the category “Wearables,” and the rule will have no effect when visitors view the details of products in other categories. The module will allow content conditions to be defined and named, searched, viewed, edited, copied and deleted.

The Content Condition Manager allows business managers to specify the application page context in which a personalization rule should be invoked by constructing a criteria consisting of any number of Boolean expressions on business object attributes combined using the Boolean operators such as AND/OR. There is generally not meant to be any restriction on the criteria format. Business managers assign unique names to content conditions to facilitate reuse. New content conditions cannot be defined on top of existing content conditions. When personalization rule deployed on a particular application page is evaluated at run-time, the object instances available on the page are used to evaluate the rule's content condition. The criteria-defining content conditions cannot generally be transformed into database queries. Database tables are used to persist content condition objects.

The Action Manager 1108 is a module to specify and configure the actions for personalization rules. For example, a business manager can create an instance of the action type “Show related links” with the name “Show links to related news” and configure it to return links to new articles retrieved via a specific database query. The module will allow actions to be created and named, searched, edited and reconfigured, copied and deleted.

The Action Manager allows business managers to select from different action types to define and configure actions for personalization rules. An analogy can be used between action types and portal objects. The goal is to turn most portal objects into action types that return HTML snippets with minimal retrofitting. The Action Manager re-uses most of the protocol that the portal framework used to interact with portal objects. The Action Manager might implement common interfaces (e.g., IPORepository, IPOContext) to store and retrieve configuration data into and from its own database tables. The Action Manager invokes the configuration workflow of a portal object when configuring an action and invokes the rendering workflow of a portal object when invoking an action for HTML snippet. The personalization behavior of portal objects is not applicable to actions. For each new release, a certain number of new action types can be made available. Business managers assign unique names to actions to facilitate re-use, and database tables are used to persist action objects.

The Rule Editor 1110 is a module to create personalization rules by associating an action with one or more user communities, a schedule and a content condition. The module will allow rules to be created and named, searched, edited, copied and deleted. If any condition or action component to be used to define a rule has not yet been created, then business managers can jump directly into the component's creation workflow from the Rule Editor. Business managers assign unique names to rules to facilitate re-use, and database tables are used to persist rule objects.

If any condition or action component to be used to define a rule has not yet been created, then optional functionality might include letting business managers jump directly into the creation workflow of a component from the Rule Editor.

The Rule Deployer 1112 will use this module to deploy rules to personalization tags on master templates and application pages and to undeploy rules from the tags. The module allows rules to be searched and added to the Deployment Pool for deployment and allows tags to be searched for deploying and undeploying rules. The Rule Deployer allows the business manager to browse personalization tags by type, application and pages. Business managers can edit deployment for one particular rule—view the list of tags the rules is deployed to and undeploy from the tags as needed. Business managers can also edit deployment at one specific tag—view the list of rules currently deployed to the tag, undeploy the rules as needed, set the rule execution order if multiple rules are deployed to the tag, set the flag to stop evaluation after the first valid rule, and selectively deploy compatible rules from the Deployment Pool to the tag. Tag metadata (type, application, page and localized display names) are specified in a message file at development/activation time. Deployment data or tag-rule associations are persisted in database tables.

The Deployment Pool 1114 is a temporary holding place for rules that are to be deployed. The functionality resembles that of an electronic shopping cart. It allows business managers to collect rules to be deployed from multiple search results. Business managers can remove individual rules form the pool or clear the entire pool. After a rule is saved to the database, the business managers can choose to add the rules to the Deployment Pool. After rules are deployed to a personalization tag, business managers can choose to remove the rules from the pool or keep the rules in the pool so that they can be deployed to another tag. The Deployment Pool is rendered in the side application content area for the Rule Editor/Deployer application module. The Deployment Pool is visible generally only when it is non-empty. Accordingly, a business manager can search for rules, add some rules from the search results to the pool, search for more rules, add more rules to the pool, and so forth. The business manager can then proceed to the Rule Deployer 1112 and search for one or more tags to deploy the content of the Deployment Pool.

The Rule Evaluator is used to check on the various rules to be invoked. When a user visits a page containing a personalization tag, the ACS server will pass the name of the personalization tag to a personalization rule engine, which will look up the rules deployed to that tag. For each rule deployed there, the personalization rule engine will evaluate all user, time and content conditions based on the visitor's profile, the current time and the current page content. If all conditions are satisfied, the personalization rule engine will invoke the action for the rule.

The Rule Evaluator can be implemented as a Java class that can be invoked when the ACS server encounters a personalization tag while rendering an interactive step. At the time of invocation, the server passes into the class the following: the name of the tag, the list of input parameters to the interactive step and the application context. The Rule Evaluator retrieves the list of rules associated with the personalization tag and evaluates each of them individually in the order set by the business managers for the tag. If the single execution flag is set for the tag, rule evaluation will terminate after the first valid rule (the rule whose conditions are all satisfied and whose action has bee executed successfully). If no rules are associated with the personalization rule tag, then either a blank space or other such symbol is returned. Evaluation of a rule involves evaluating the Time Condition, User Community Condition and Content condition associated with the rule, in that order. If all three conditions are satisfied, then the action workflow associated with the rule is invoked. The Rule Evaluator might optionally be implemented as a template interactive composite step (tics) that can be invoked when the ACS server encounters a personalization tag while rendering an interactive step.

To associate a default rule or a default action with a personalization tag, business managers can define a rule whose conditions are very general (such as “For all Uses,” “Always,” or “No Condition”) and set this rule to be the last rule to be executed at the tag. This yields the same functionality as a default rule or a default action.

Content Group Administration 1118 is a user interface that allows content groups to be defined and named, searched, edited and deleted. The Content Condition Manager 1106 allows business managers to specify page content conditions by forming criteria on business objects. To facilitate business object selection when forming criteria, objects can be grouped logically. The business managers can logically group business objects that are exposed to end users for personalization. A set of content groups will be pre-defined at development and activation time and will be read-only after activation. For instance, the default content group that includes all exposed business objects will be delivered out of the box. Other pre-defined content groups may group business objects by applications. At run time, business managers can define new groups and edit existing groups as the need arises. Business managers assign unique names to content groups to facilitate re-use. Database tables are used to persist content group objects. Content Group Administration is not specific to personalization framework and can be used as a more generalized (and accessible) module.

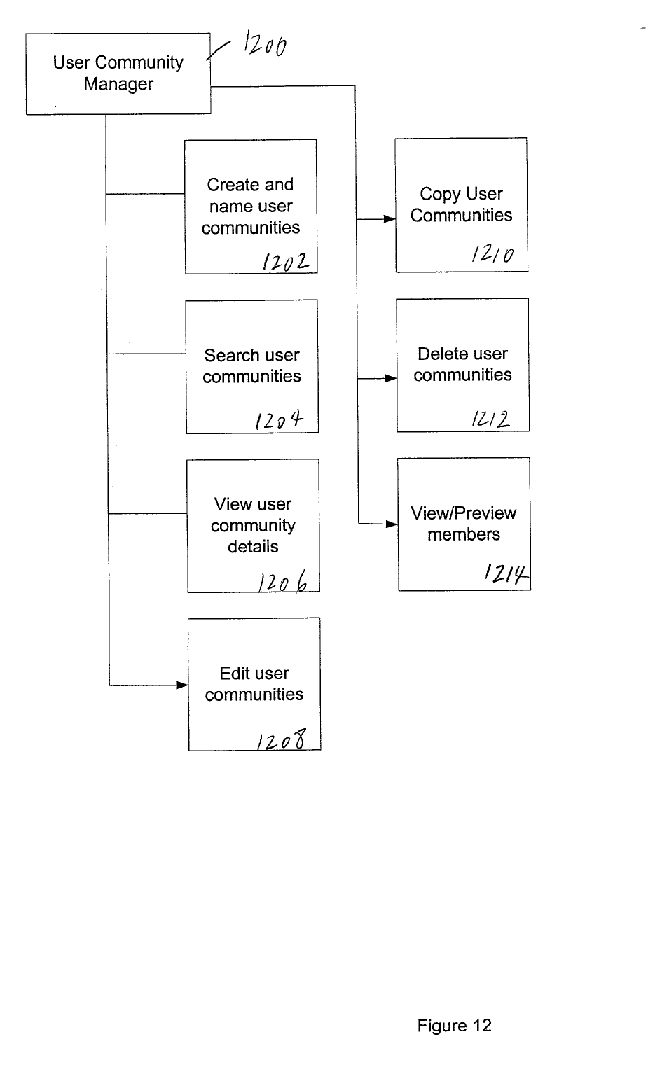

FIG. 12 next shows the User Community Manager 1200 and certain representative features that might be implemented. For any of the features described below (for this and subsequent figures), the implementation is intended to be any coding of the described features, via standard techniques and practices available to programmers that will provide the described functionality.

The feature create and name user communities (1202) allows a new user community to be named, described and defined via criteria on the user attributes. This feature also allows a new user community to be defined using existing user communities. The feature search user communities by keywords (1204) is used to display results in a paginated table and to allow business managers to view/edit/copy/delete user communities. The search feature might also provide for search of communities by users, which allows a list to be generated of all the user communities, based upon one or more user login IDs. The feature view user community details (1206) displays the name, description, and criteria specification of a community. The feature edit user communities (1208) allows the name, description, and criteria of a user community to be edited. The feature copy user communities (1210) allows a new user community to be created by copying an existing community. All parameters of the source except for the name will be copied over. The feature delete user communities (1212) will allow user communities to be deleted only if not in use.

The feature view/preview members in a user community (1214) will allow business managers to preview members in a user community before saving the information. This feature will also allow business managers to view members in a user community selected from the search result page. The user community membership preview functionality can also be configured in a variety of ways, including listing users: from all organizations; only from organizations categorized as BUYER in the ACS system; only from organizations categorized as SELLER in the ACS system; or only from trading partners which are organizations with whom the organization of the current user has an explicit business relationship, as set up in the ACS system. These user listings are meant to be representative examples only, and many other listings might be generated in light of such examples.

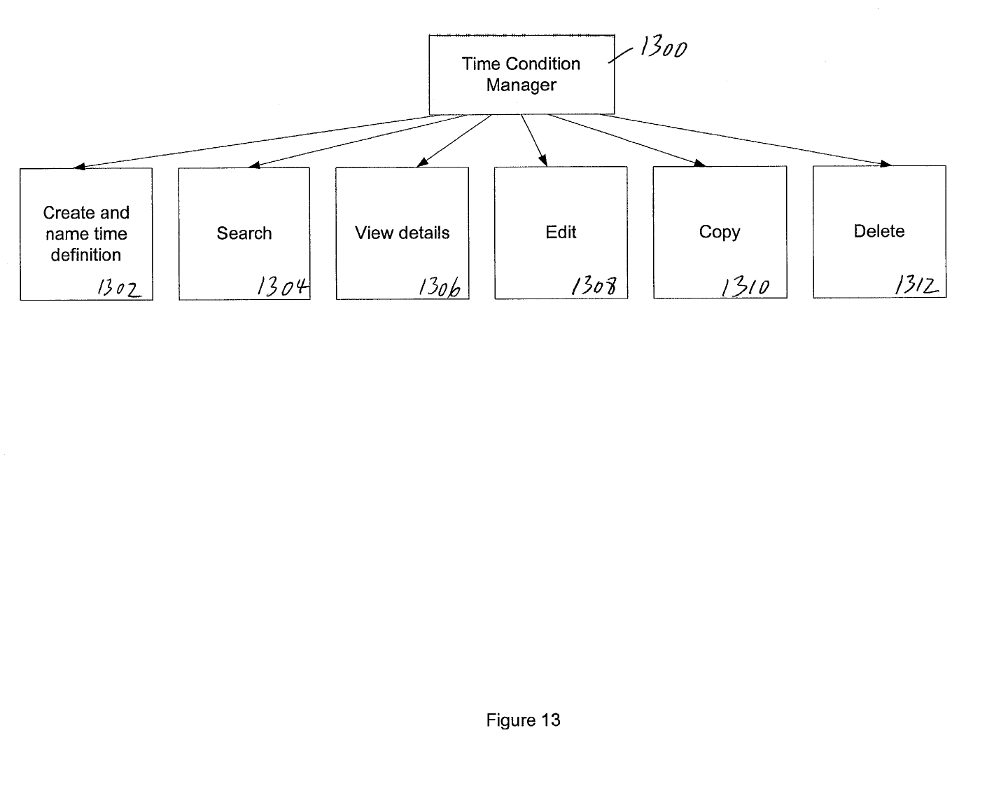

Certain representative features of the Time Condition Manager 1300 are further detailed in FIG. 13. The feature create and name time definitions (1302) will allow a time period to be defined and named. The following attributes (for example) can be specified: start and end date or time, active duration, time zone, and daily/weekly/monthly recurrence specification. The search feature (1304) encompasses the searching of time definitions by keywords in the name or description, start and end dates, by recurrence type, and by expiration flag. The results are displayed in a paginated table and allow business managers to view/edit/delete schedules. The feature view details (1306) provides for viewing time definition details. The feature then displays a time definition's name, description, start and end date/time, time zone, active duration, and recurrence specification. The feature edit (1308) allows for all attributes of a time definition to be edited. The feature copy (1310) allows a new time definition to be created by copying an existing one. All parameters of the source except for the name will be copied over. The feature delete (1312) will allow a time definition to be deleted only if it is not in use.

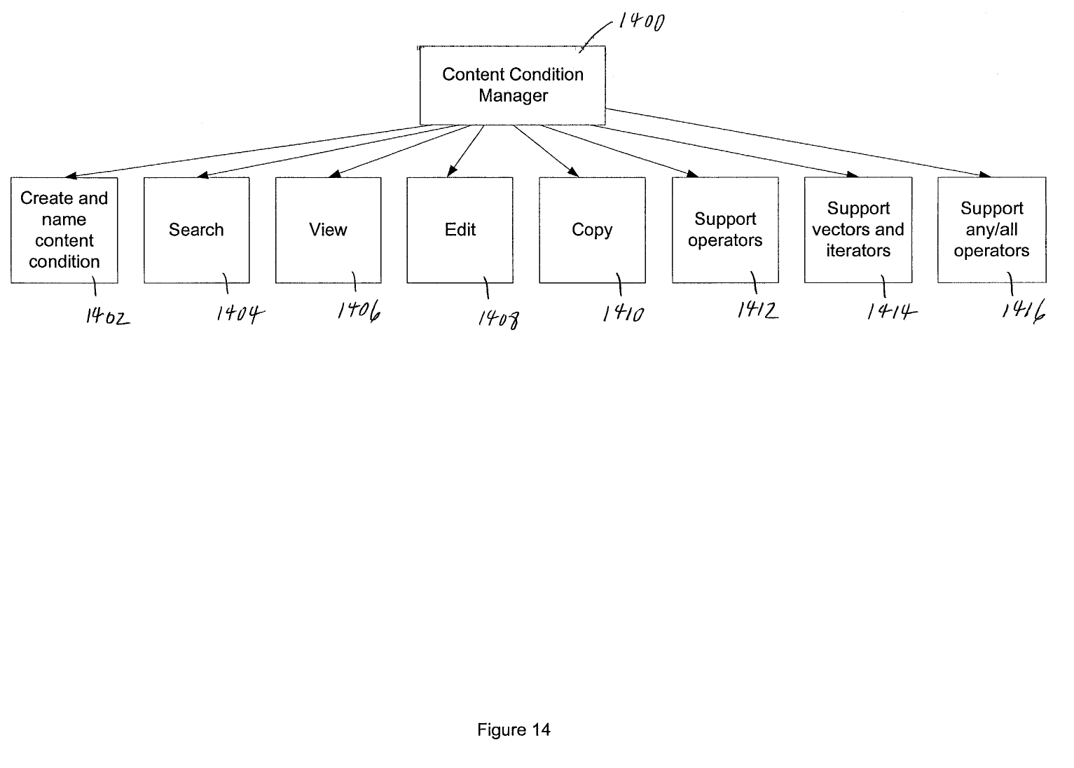

Certain representative features of the Content Condition Manager 1400 are detailed in FIG. 14. The feature create and name a content condition (1402) allows a new content condition to be named, described and defined via criteria on object attributes. The feature search (1404) allows a user to search content conditions by keywords in the name or description and by object. The results can be displayed in a paginated table and allow business managers to view/edit/copy/delete various content conditions. The feature edit (1406) allows a content conditions name, description and criteria list to be edited. The feature copy (1408) allows a content condition to be created by copying an existing one. All parameters of the source except for the name will be copied over. The feature delete (1410) allows a content condition to be deleted if not in use. The feature support operations (1412) allows for support of standard operators specific to each data type (i.e., <, >, >=, etc.). The feature support vectors and iterators (1414) allows conditions to be formed on vectors or iterators. The feature support any/all operators (1416) will provide for support of any/all operators on a set of attributes (e.g., If any(product expiration date) is before today, then a true condition will result).

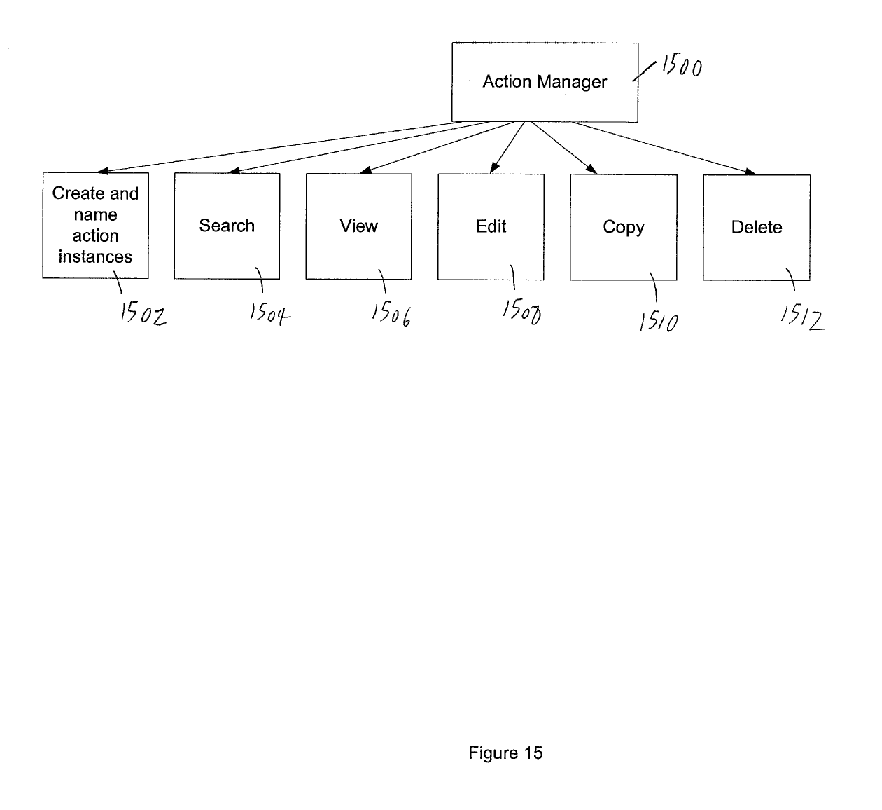

Certain representative features of the Action Manager 1500 are shown in FIG. 15. The feature create and name action instance (1502) allows a new action instance to be created, configured and named. Each action instance will have a unique name, and optional description, and an action type. The configuration workflow implemented by each action type will be invoked to configure the new instance. The feature search (1504) can search by action type and keywords in name or description. The results might be displayed in paginated table format and will allow business managers to view/edit/copy/delete actions. The feature view action details (1506) will be used to display the name, description and action type of an action instance. A list can also be provided of the rules currently using the action. The edit action feature (1508) allows the name and description of an action instance to be edited or reconfigured, wherein action types cannot generally be edited. The copy action feature (1510) allows a new action instance to be created by copying an existing instance. All parameters of the source action instance, except for the name, will be copied over, including all configuration parameters. The delete action feature (1512) allows the action instances to be deleted only if not in use.

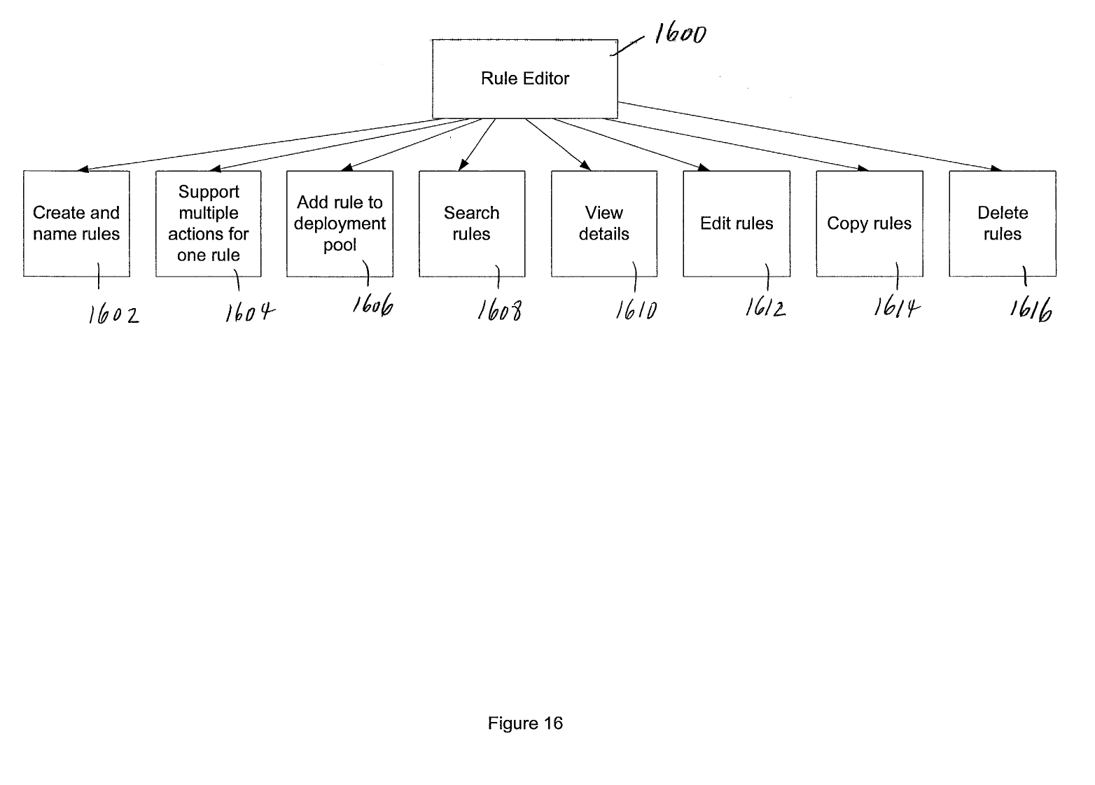

Certain representative features of the Rule Editor 1600 are shown in FIG. 16. The feature create and name rules (1602) allows a new rule to be named, described and defined via the selection of one or more user communities, one schedule, one content condition and one action. The feature support multiple actions for one rule (1604) allows a business manager to specify multiple actions for one rule. The actions will be executed sequentially in the order specified by the business managers or in parallel. The feature add rule to deployment pool (1606) allows a rule to be added after saving. On the save status page, a check box is provided to allow the saved rule to be added to the Deployment Pool. The feature search rules (1608) will allow the rules to be searched by keywords in name or description, by user communities, by schedules, by content conditions, by actions and enabled flag. The results are displayed in a paginated table and allow the business managers to view/edit/copy/delete rules. The feature also allows business managers to select rules on the current page and add them to the Deployment Pool. The feature also allows business managers to edit deployment for each rule (i.e., undeploy the rule from tags only). The feature view details (1610) is used to display a rule's name, description, enabled flag, user/time/content conditions and action(s). The feature can also be used to list all tags to which the rule is currently deployed. The feature edit rules (1612) allows a rule's name, description, enabled flag, user/time/content conditions and action(s) to be edited. The feature copy rules (1614) allows a new rule to be created by copying an existing one. All parameters of the source except for the name will be copied over. Deployment data of the source rule will not generally be copied to the new rule. The feature delete rules (1616) allows rules to be deleted.

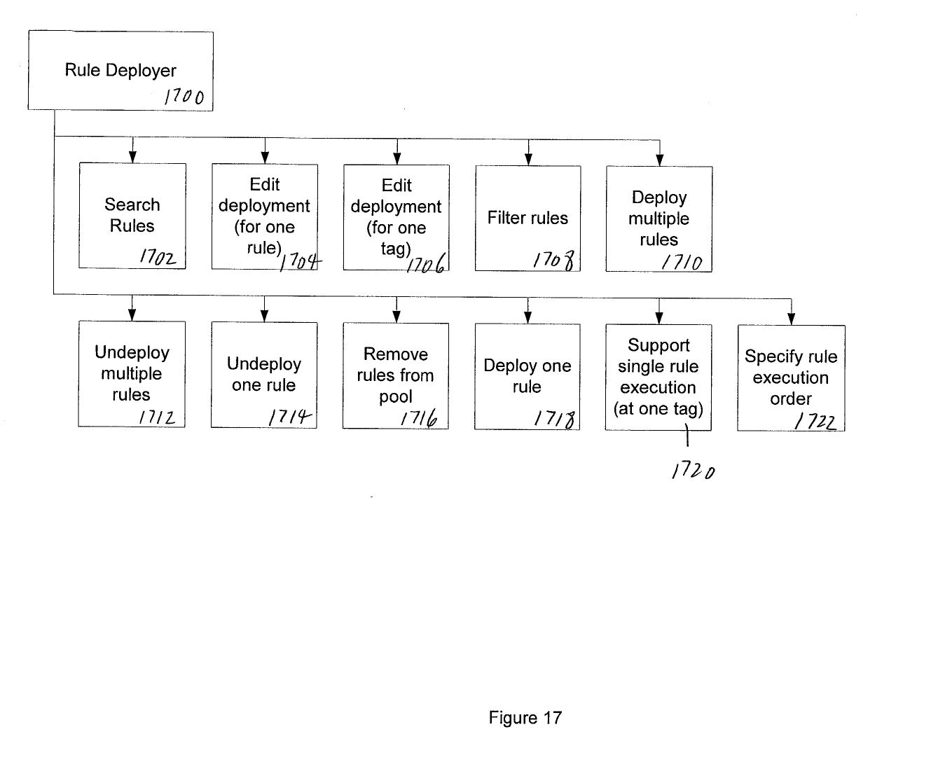

Certain representative features of Rule Deployer 1700 are shown in FIG. 17. The feature search rules 1702 can search by keywords in name or description, by user communities, by schedules, by content conditions, by actions and enabled flag. The feature can display results in a paginated table and allow business managers to select rules on the current page and add them to the Deployment Pool. This feature also allows business managers to edit deployment for each rule (i.e., undeploy the rule for tags only). The search feature is used to search personalization tags by tag type, by application and by page. The feature can then display results in a paginated table and allow business managers to edit deployment at each tag (i.e., undeploy rules from the tag and/or deploy compatible rules in the Deployment Pool to the tag). The feature edit deployment (for one rule) (1704) is used to list all tags a rule is currently deployed to, and will allow managers to undeploy the rule from any of the tags. The feature edit deployment (for one tag) (1706) is used to list all rules currently deployed to one particular tag, and allows managers to undeploy any of the rules from the tag. The feature allows business managers to deploy rules in the Deployment Pool that are compatible to the tag. The feature filter rules (1708) is used to filter rules in the Deployment Pool based upon tag compatibility. On the “Edit Deployment (for one tag)” page, if the Deployment Pool is not empty, then filter all rules in the pool based on tag compatibility and append the results to the rule listing on the page. The feature deploy multiple rules (1710) is used to deploy multiple rules to one tag in one operation. The feature undeploy multiple rules (1712) is used to undeploy multiple rules from one tag in one operation. The feature undeploy one rule (1714) is used to undeploy one rule from multiple tags in one operation. This feature remove rules from pool (1716) is used to remove rules from the Deployment Pool after deployment. After deployment data is saved, the business manager can remove rules just deployed from the Deployment Pool. The feature deploy one rule (1718) provides for deployment of one rule to multiple tags in one operation. This feature allows a business manager to deploy one rule to the same set of tags in which another rule is currently deployed. The feature support single rule execution (at one tag) (1720) allows a business manager to specify whether a tag is “single execution” or not. Rule evaluation will stop after the first rule deployed to the tag has been successfully executed. The feature specify rule execution order (1722) allows a business manager to specify the execution order for multiple rules deployed to the same tag. Execution order is editable at runtime.

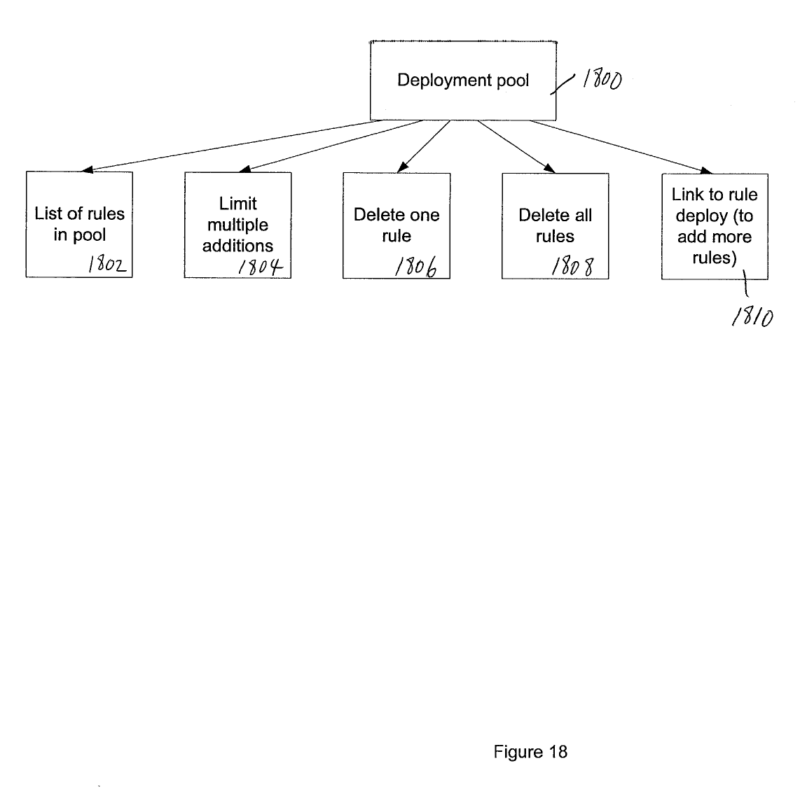

Certain representative features of the Deployment Pool 1800 are shown in FIG. 18. Feature 1802 provides a list of rules in the pool, i.e., alphabetically by name. Feature 1804 limits multiple additions of rules to the deployment pool. For instance, the module can forbid one rule from being added to the pool multiple times. Feature 1806 allows for deletion of one rule from the pool. Feature 1808 allows business managers to remove all rules from the pool in one operation. Feature 1810 provides a link to the Deployer to add more rules. A link is placed to the Deployer next to the Deployment Pool to allow business managers to add rules to the pool.

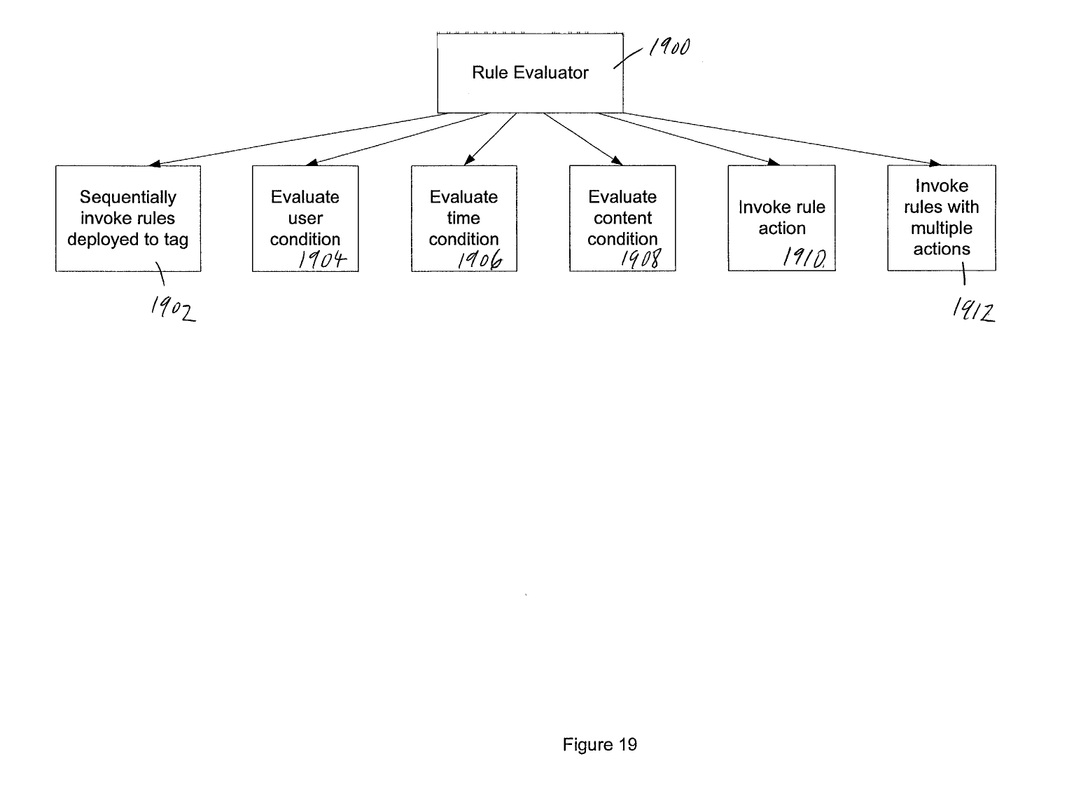

Certain representative features of the Rule Evaluator 1900 are shown in FIG. 19. Feature 1902 provides for a given personalization tag name the ability to look up all rules deployed to the tag and to invoke the rules sequentially by ascending execution order. Given the personalization tag, all of the rules deployed to that tag are looked up. The rules are invoked sequentially by ascending execution order. If the tag is “single execution,” the feature will stop evaluating the rules after the first successful rule execution. Feature 1904 allows for the evaluation of a user-condition based on the current user. Feature 1906 provides for evaluation of a time condition based on current time. Feature 1908 provides for the evaluation of content condition based on objects that the ACS server framework passes to the Rule Engine. Feature 1910 invokes a rule action when all of the conditions of the rule are satisfied. All of the application objects are passed to the action workflow. Feature 1912 provides for invoking rules with multiple actions. For such rules, the module invokes then sequentially by ascending execution order or in parallel when all conditions of the rule are satisfied.

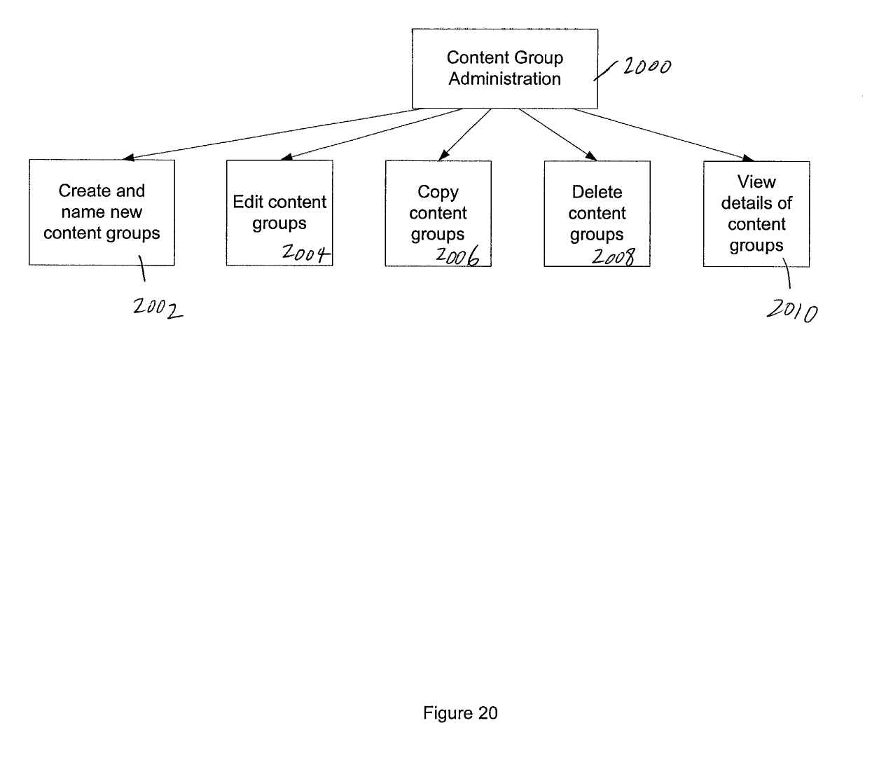

Certain representative features of Content Group Administration 2000 are shown in FIG. 20. Feature 2002 allows a new content group to be created, named, and described. This feature further allows available business objects to be selected into the new content group. Business objects can be listed by localized or more user-friendly names. Feature 2004 allows all attributes of a content group to be edited. Feature 2006 allows a new content group to be created by copying all attributes of an existing content group except for the content group name. Feature 2008 allows a content group to be deleted. In general, content groups delivered with the system “out of the box” may not be deleted. Also content groups in use may not be deleted. Feature 2010 provides for viewing the details of content groups by displaying all the attributes of a content group.

While the invention has been illustrated and described in detail in the drawings and foregoing description, such illustrations and descriptions are to be considered as exemplary and not restrictive in character, it being understood that only certain embodiment(s) and minor variants thereof have been shown and described, and that all changes and modifications that come within the spirit of the invention are desired to be protected.

1. A framework for implementing and deploying personalized rules for performing certain actions in association with at least one application running on a processor device in a distributed computer network, the framework comprising:
at least one rule having a set of conditions and associated actions;
at least one application page associated with each application; and
at least one tag defined in a known location of the at least one application page,
wherein a rule is deployed by associating certain actions with certain tags, with the action being executed when the tag is encountered in rendering the application page, and the set of conditions for the associated rule is satisfied.

2. The framework of claim 1, wherein the rule is deployed in a runtime environment by associating the rule actions with certain tags that are executed during runtime.

3. The framework of claim 1, wherein each tag is registered with a centralized file so that the tags can be collectively referenced.

4. The framework of claim 1, wherein the application page includes source code having wire frames, with the tags being included within the source code.

5. The framework of claim 1, wherein the application page includes source code having master template HTML files, with tags being included within the source code.

6. The framework of claim 1, wherein the actions include action workflows.

7. The framework of claim 6, wherein the action workflows affect display results, including returning HTML snippets to the rendered display result.

8. The framework of claim 6, wherein the action workflows perform results that are not associated with a display result.

9. The framework of claim 1, wherein the at least one rule is stored in a storage device for searchable reference and retrieval.

10. The framework of claim 9, wherein a rule manager and deployment tool is provided which includes:
at least one interface for creating and storing new rules;
at least one interface for searching and retrieving a list of existing rules; and
at least one interface for selectively associating the actions of desired rules with certain tags that are associated with the application pages.

11. The framework of claim 9, wherein an interface is further included to search the available tags in order to determine which application or application pages would be able to handle deployment of a particular action.

12. The framework of claim 10, wherein a validation interface is further included to validate whether a particular action can be assigned to a particular tag.

13. The framework of claim 10, wherein the tool is provided as an online application whereby rules can be deployed on a runtime basis for a set of applications and applications pages.

14. A framework for implementing and deploying personalized rules for performing certain actions in association with at least one application running on a processor in a distributed computer network, the framework comprising:
at least one rule having a set of conditions, the set of conditions being associated with an arbitrary action;
at least one application page associated with each application; and
at least one tag defined in a known location of the at least one application page,
wherein a rule is deployed by associating the arbitrary action with certain tags, with the arbitrary action being executed when the tag is encountered in rendering the application page, and the set of conditions for the rule are satisfied.

15. The framework of claim 14, wherein the arbitrary action implements a predetermined interface which will then interact with the framework according to known parameters.

16. The framework of claim 15, wherein the framework is extensible with additional actions being incorporated via the predetermined interface.

17. A tool for implementing and deploying personalized rules for performing certain actions in association with at least one application running on a processor in a distributed computer network, the tool comprising:
at least one interface for creating rules having a set of conditions, the set of conditions being associated with at least one action, whereby the rules are retrievably stored;
at least one interface for searching and retrieving a list of created and existing rules; and
at least one interface for deploying the rules by selectively associating the actions of certain rules with certain tags, each tag having been defined in a known location of the at least one application,
wherein the action is executed when the tag is encountered in the process of rendering the application, and the set of conditions for the associated rule are satisfied.

18. The tool for implementing and deploying personalized rules according to claim 17, wherein the tool is provided as an online application for implementing rules on a runtime basis without interrupting the running of computers comprising the distributed computer network.

19. The tool for implementing and deploying personalized rules according to claim 17, wherein the tags are registered in a searchable file.

20. The tool for implementing and deploying personalized rules according to claim 19, wherein an interface is additionally provided to search for appropriate tags with which certain actions can be associated.
